(19) United States
(12) Patent Application Publication
(10) Pub. No.: US 2024/0084717 A1
(43) Pub. Date: Mar. 14, 2024

(54) ROTOR FOR A TURBOMACHINE CENTRIFUGAL BREATHER

(71) Applicant: SAFRAN HELICOPTER ENGINES, Bordes (FR)

(72) Inventors: Mathieu Jean-Baptiste MARSAUDON, Moissy-Cramayel (FR); Olivier Philippe David BERTEAUX, Moissy-Cramayel (FR)

(21) Appl. No.: 18/261,094

(22) PCT Filed: Feb. 9, 2022
(86) PCT No.: PCT/FR2022/050233

§ 371 Date: Jul. 11, 2023

(30) Foreign Application Priority Data
Feb. 19, 2021 (FR) FR2101643

(51) Int. Cl. F01D 25/18; F01M 13/04

(52) U.S. Cl. CPC F01D 25/18; F01M 13/04; B33Y 80/00; F01M 2013/0422; F05D 2260/609; F05D 2260/98

(57) ABSTRACT

A rotor for a centrifugal breather for an air/oil mixture of a turbomachine, this rotor including a hollow shaft extending along an axis, a pinion for rotating the hollow shaft, this pinion extending around the axis and being formed of a single part and in a first material with at least one first portion of the hollow shaft, and an annular structure extending around the axis and constrained to rotate with the shaft, this structure being produced in a second material, different from the first material, wherein the structure is made integral with the shaft by additive manufacturing of this structure directly on at least one annular surface of the pinion which forms at least one annular support surface for this additive manufacturing.

### TECHNICAL FIELD OF THE INVENTION

The invention concerns a rotor for a turbomachine centrifugal breather and a breather comprising such a rotor. The invention also relates to a method for manufacturing this rotor.

### TECHNICAL BACKGROUND

The turbomachines are complex systems implementing a number of rotating assemblies (turbines, compressors, etc.) which must be equipped with sealing devices. These sealing devices are generally produced by pressurised air labyrinths provided in the vicinity of the rotating assemblies. To do this, air is collected directly from the air duct of the turbomachine. This air then passes through the turbomachine via the various labyrinths provided for this purpose, then being evacuated to the outside of the turbomachine to limit pressure build-up in other areas of the turbomachine, in particular the reducer, the accessory gearbox, etc. This air, having passed through various areas of the turbomachine, is charged with oil used to cool and lubricate the bearings and the pinions of the rotating assemblies. To prevent the release of oil-charged air, reduce the ecological impact of the turbomachines, reduce oil consumption and limit the operations to refill oil reserves, it is important to use breathers to allow separate the oil from the air before evacuating the air to the outside of the turbomachine.

Such a breather is generally arranged and driven by a mechanical power take-off at the level of the accessory gearbox or of the reducer of the turbomachine.

In a known way, such a centrifugal breather comprises one or more enclosures for centrifugal separation of the air/oil mixture arranged around a hollow shaft and delimited by an external annular wall and an internal annular wall. The breather also comprises an axial inlet for supplying the enclosure with the air/oil mixture, and a peripheral oil outlet provided in the external wall. When the breather is rotated, usually by means of a pinion in the accessory gearbox or in the reducer, the oil is naturally driven by centrifugal force towards the oil outlet provided at the periphery of the breather. A de-oiled air outlet is also provided in the internal wall and connected to the hollow shaft, allowing the air to be evacuated to the outside.

Some breathers, such as the one described in the application WO-A1-2011/004023, also comprise filters arranged in the enclosure of the breather to improve the capture of oil drops and thus promote the de-oiling of the mixture. In fact, the filters increase the available contact surface and therefore improve the likelihood of a drop of oil conveyed by the mixture flow being caught on a wall. These filters are generally made of a metal foam, such as a foam marketed under the name Retimet®.

However, the performance of the known breathers is generally hampered by internal pressure losses, which are due to two causes in particular: the shape of the duct, comprising the centrifuge enclosure, through which the air flow passes during de-oiling, and the presence of metal foam.

As far as the internal shapes of the breather delimiting the duct through which the airflow passes, the manufacturing method can be limiting in terms of the potential optimum geometry to be carried out.

As far as the presence of metal foam is concerned, the pressure losses are due to the fact that at high speeds (for example, for speeds in the range of 6,000 to 25,000 rpm), the frontal surface formed by the metal foam acts like a wall and the degree of penetration of the air particles into the foam is low.

In response to these problems and to optimise the de-oiling performance while limiting the pressure losses through the breather, the Applicant has already proposed in the applications WO-A1-2020/008153 and WO-A1-2020/008156 to replace the filter with an annular lattice structure produced by additive manufacturing.

In practice, the lattice structure is produced and then mounted and attached to the shaft using a nut (this is referred to as a cartridge fitted to the shaft). The nut is screwed onto an external thread on the shaft and clamps the lattice structure axially against a shoulder on the shaft. The nut can comprise means for immobilising the lattice structure in rotation relative to the shaft.

The attachment of the lattice structure to the shaft is relatively bulky because the nut and the thread of the shaft occupy a relatively bulky annular space in the axial and radial directions, which cannot be occupied by the lattice structure and which therefore limits the dimensions of this structure and therefore the performance of the breather. In addition, the thread makes the shaft more complex to manufacture, and the attachment of the lattice structure with a nut has an impact on the time required to manufacture and assemble the breather.

The present invention proposes a simple, effective and economical solution to at least some of these problems.

### SUMMARY OF THE INVENTION

To this end, the invention relates to a rotor for a centrifugal breather for a turbomachine air/oil mixture, this rotor comprising:
a hollow shaft extending along an axis X and defining an internal air circulation cavity after separation of said mixture,
a pinion for rotating the hollow shaft, this pinion extending around the axis and being formed in one piece and from a first material with at least one first portion of the hollow shaft, and
an annular structure, preferably in the form of a lattice, extending around the axis and secured in rotation to the shaft, this structure being made of a second material different from the first material and being configured to ensure a centrifugal separation of said mixture,

characterised in that said structure is made secured to the shaft by the additive manufacture of this structure directly on at least one annular surface of the pinion which forms at least one annular support surface for this additive manufacture.

The invention allows to simplify the method for manufacturing the rotor by removing the step of the prior technique consisting of screwing a nut onto the shaft. The annular structure is attached to the shaft automatically as a result of it manufacturing mode, by additive manufacturing, directly on the pinion. There is therefore no need for special attachment elements or a special attachment step, which allows to simplify and reduces the manufacturing time of the rotor. In addition, the elimination of the nut allows to eliminate the thread of the shaft of the prior technique and allows to optimise the space available for the annular structure, which can therefore be oversized compared with the previous technique. This improves the performance of the breather. Finally, keeping two different materials for the annular structure on the one hand, and for the pinion and at least one portion of the shaft on the other, means that these materials can be chosen according to the mechanical and chemical resistance and service life requirements of the different portions of the rotor.

The rotor according to the invention may comprise one or more of the following characteristics, taken in isolation from each other or in combination with each other:
the pinion is located at a longitudinal end of said first portion of said shaft and said at least one annular surface is located on a side of the pinion opposite to this first portion;
said at least one annular surface is perpendicular to said axis;
said structure is produced by additive manufacturing on a single annular surface of the pinion, this surface being flat and extending from the internal periphery of the pinion to the external periphery of the pinion;
the pinion has an external periphery comprising a toothing, an internal periphery connected to the shaft, and an intermediate annular web extending between its internal and external peripheries and having a thickness measured along said axis which is less than the thicknesses of said peripheries measured along the same axis;
the annular structure is made in one piece and from said second material with at least one second portion of said shaft;
the first material is chosen from a steel hardenable by case-hardening or nitriding thermal treatment, for example of the E16NCD13 and E32CDV13 type; these steel grades allow a hardening by thermal treatment (case-hardening or nitriding); the choice of this grade allows to obtain the mechanical properties necessary for good behaviour of the gearing in operation;
the second material is a stainless steel, for example of the 17-4 PH type; as the structure may be in contact with the ambient air outside the turbomachine, this material allows to prevent an oxidation and any risk of damage.

The present invention also relates to a centrifugal breather for a turbomachine air/oil mixture, comprising a rotor as described above.

This invention also relates to a method for manufacturing a rotor as described above.

The method comprises the steps of:
a) manufacturing the pinion and at least one portion of the hollow shaft in a single piece from a first material,
b) additive manufacturing, for example on powder beds, of the annular structure in a second material directly on at least one annular surface of the pinion.

The method according to the invention allows to obtain the rotor as described above, for a centrifugal breather for a turbomachine air/oil mixture. This rotor comprises:
a hollow shaft extending along an axis X and defining an internal air circulation cavity after separation of said mixture,
a pinion for rotating the hollow shaft, this pinion extending around the axis and being formed in a single piece and in a first material with at least one first portion of the hollow shaft, and
an annular structure, preferably in the form of a lattice, extending around the axis and secured in rotation to the shaft, this structure being made of a second material different from the first material and being configured to ensure a centrifugal separation of said mixture,

said annular structure is made secured to the shaft by the additive manufacturing of this structure directly on at least one annular surface of the pinion which forms at least one annular support surface for this additive manufacturing.

The rotor obtained by the manufacturing method can thus comprise at least one or more of the characteristics associated with the rotor, as described above. These characteristics can be taken in isolation or in combination.

The pinion may be located at a longitudinal end of said first portion of said shaft and said at least one annular surface is located on a side of the pinion opposite to this first portion.

The pinion may have an external periphery comprising a toothing, an internal periphery connected to the shaft, and an intermediate annular web extending between its internal and external peripheries. This annular web may have a thickness measured along said axis which is less than the thicknesses of said peripheries measured along the same axis.

Preferably, step a) comprises the machining of a metal alloy block, and also preferably the treatment of this block after machining by case-hardening or nitriding.

Advantageously, step b) comprises the simultaneous manufacture of the annular structure and a second portion of said shaft.

This second portion of said shaft may be located at the internal periphery of the annular structure and extends towards the top of the pinion from its annular surface and in the extension with the first portion of said shaft.

Said annular surface of the pinion may be unique.

### BRIEF DESCRIPTION OF THE FIGURES

Further characteristics and advantages of the invention will become apparent from the following detailed description, for the understanding of which reference is made to the attached drawings in which:

FIG. 1 shows a schematic perspective view of a centrifugal breather for a turbomachine, cut along a plane of symmetry;

FIG. 2 shows a partial schematic perspective view, cut along a plane of symmetry, of a centrifuge enclosure of the breather of FIG. 1;

FIG. 3 shows a schematic perspective view of a segment of a lattice structure of the centrifuge enclosure of FIG. 2;

FIG. 4 shows a schematic perspective view of a method for manufacturing, and in particular assembling, a centrifugal breather rotor, according to the technique prior to the present invention;

FIG. 5 shows a partial schematic cross-section of a pinion on which an annular lattice structure is produced by additive manufacturing, and illustrates a method for manufacturing a rotor according to the invention;

FIG. 6 shows a schematic perspective view of a pinion and a portion of a shaft, for implementing the method according to the invention; and

FIG. 7 shows another schematic perspective view of the pinion and of the shaft portion of FIG. 6.

### DETAILED DESCRIPTION OF THE INVENTION

In the figures, the scales and the proportions are not strictly respected for the purposes of illustration and clarity.

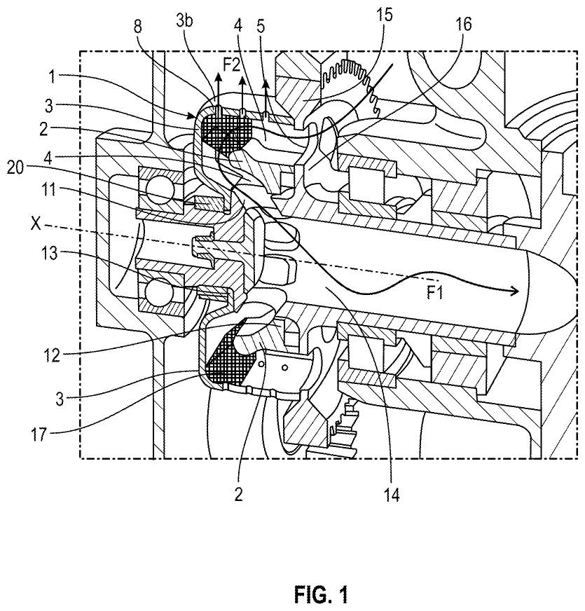

A centrifugal breather for a turbomachine, in particular for an aircraft, is shown in FIG. 1.

In particular, this breather comprises in particular a part 1 movable in rotation about a longitudinal axis X.

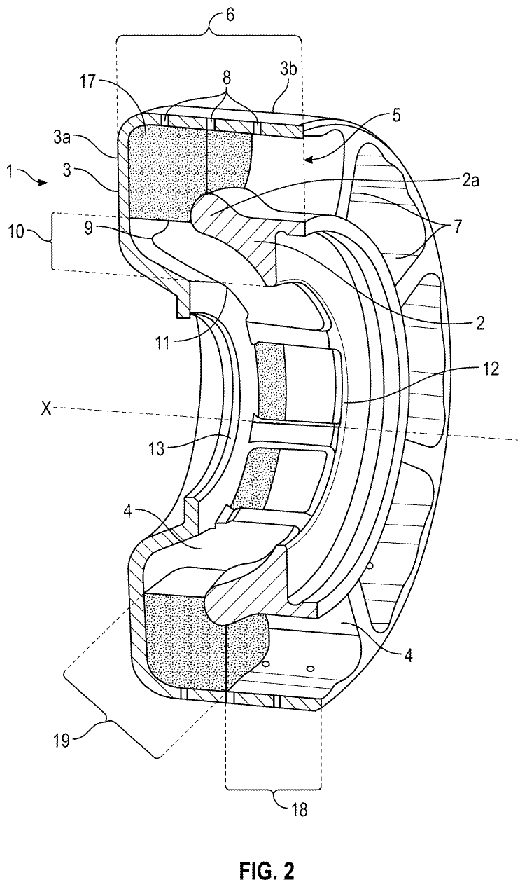

As shown in more detail in FIG. 2, the part 1 comprises a structural portion which comprises a first shell 2 surrounded by a second shell 3. The space between the two shells 2, 3, forms a duct 4 of revolution around the axis X, intended to circulate a mixture of air and oil to be separated.

The duct 4 comprises an axial inlet 5 for the inlet of the mixture of air and oil to be separated. This axial inlet 5 corresponds to a first end of a first portion 6 of the duct 4 which extends essentially axially, with a view to centrifuging the mixture. The first, axially extending portion of the duct 6 acts as a centrifuge enclosure, as this is where the centrifugal force is exerted with the greatest force on the air/oil mixture. It is therefore referred to as a centrifuge enclosure 6 in the remainder of this description.

The duct 4 also comprises a plurality of compartments distributed circumferentially around the axis X. The compartments are formed by radially extending longitudinal partitions 7. Advantageously, these longitudinal partitions 7 connect the first 2 and the second 3 shell, forming a connection that secures them together. Each compartment communicates with the axial inlet 5 for the mixture. The axial partitions 7 form fins that drive in rotation the mixture entering the adjacent compartments.

At its second axial end, the centrifuge enclosure 6 is axially closed by a segment 3a of the second shell 3, substantially perpendicular to the axis X, and comprises a radial opening 9 towards the axis X between the first 2 and the second shell 3. The second shell 3 forms a radially external wall 3b of the centrifuge enclosure 6 which is substantially annular, between the inlet 6 and the portion 3a of the second shell which axially limits the centrifuge enclosure 6 at its second end. The centrifuge enclosure 6 comprises a plurality of radial oil outlets 8, in the form of through orifices provided in the radially external wall 3b, and is configured to be able to evacuate the oil separated from the mixture by the effect of the centrifugal force of the breather. Each compartment of the duct 4 is connected to one or more radial oil outlets 8.

The first shell 2 forms a radially internal wall of the compartments of the duct in the centrifuge enclosure 8. It stops axially before the axial segment 3a of the second shell 3, starting from the inlet 6 of the duct, to provide the radial opening 9 towards the inside at the second end of the centrifuge enclosure 6. Its shape can be optimised to promote the separation of the oil and minimise the pressure losses, in particular at the level of the elbow formed at the level of the radial outlet. In the example shown, the radially internal wall 2 is substantially annular starting from the axial inlet 5 and comprises an axial end 2a opposite to the radial inlet 5 forming a rounded circumferential bead or a plate at the level of the second end of the centrifuge enclosure 6. This shape of the axial end 2a of the first shell tends to send the fluid radially outwards through the elbow formed in the duct 4 at the outlet of the centrifuge enclosure 6, so as to optimise the flowing of the air/oil mixture flow.

The duct 4 comprises a second portion 10 which communicates with the centrifuge enclosure 6 through the radial opening 9 between the first 2 and the second 3 shells and which is configured to guide the fluid towards a radial outlet 11 in an empty cylindrical space, which extends axially between the limits of the centrifuge enclosure 6. The first 2 and the second 3 shells form collars 12, 13, which limit said empty cylinder space.

These collars 12, 13 are configured to connect the part 1 to a hollow shaft 14, shown in FIG. 1, which drives the part in rotation. The cross-section of the duct 4 in a longitudinal plane has an elbow shape optimised for guiding the de-oiled air towards the radial internal outlet 12.

The part 1 is used in a breather which comprises a pinion 15 for rotating the shaft 14 and the part 1. In the example shown, the pinion 15 comprises a web 16 which is securely connected to the hollow shaft 14 and which comprises openings facing the axial inlet 5 for the passage of the mixture into the compartments of the duct 4.

The part 1 also comprises at least one honeycomb lattice structure 17 housed in the centrifuge enclosure 6.

The centrifuge enclosure 6 may comprise two successive distinct spaces: a free space 18 located upstream with reference to the flowing of the mixture in the enclosure 6, and a space 19 filled by the structure 17. The free space 18 is supplied with mixture through the opening of the compartment on the axial inlet 5 and opens into the space 19 filled by the structure 17. The space 19 filled by the structure 17 opens into the second portion 10 of the duct.

As indicated by the arrow F1 in FIG. 1, the air/oil mixture enters the movable part 1 through the openings in the web 16. In the free space 18, the longitudinal partitions 7 drive the mixture in rotation. As the flow F1 passes through this first portion 18 of the enclosure, a first de-oiling phase is carried out by centrifugation. The lattice structure 17 has a function of capturing oil drops not extracted during the first phase. By centrifugal effect, the oil is evacuated towards the radial outlets 8 through the structure 17, as shown by the arrows F2. This second de-oiling phase is also carried out in the space 19 occupied by the structure 17 without any significant pressure losses due to the axial attack of the oil drops and of the lattice structure.

Next, the de-oiled air that has passed through the structure 17 in the duct 4 arrives in the hollow shaft 14 to be evacuated.

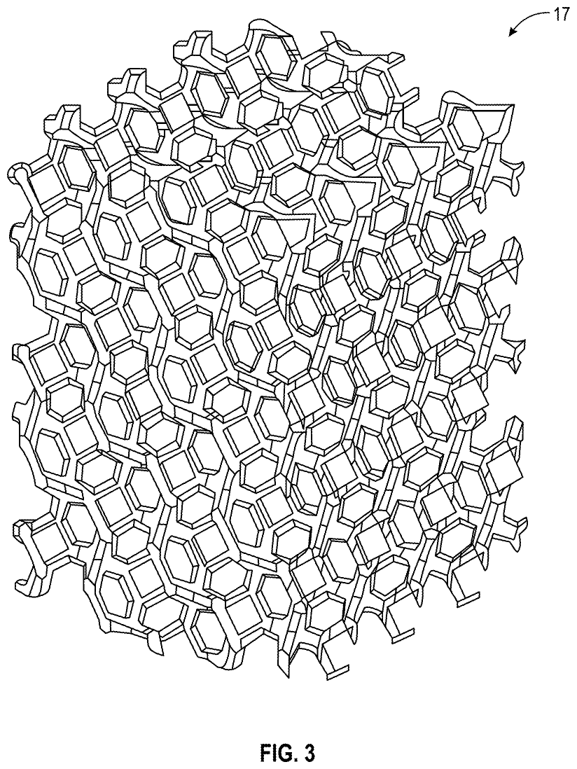

The structure 17 is for example formed by the repetition in three spatial dimensions of a single pattern arranged so that the voids between the material communicate so as to organise paths through the material of the lattice in the three spatial dimensions, said paths having elbows and/or pinches and/or bifurcations. There are several possible embodiments for such a structure or lattice, such as that shown in FIG. 3.

The configurations shown in FIGS. 1 and 2 are not limitative. In particular, the structure 17 can be formed in a single piece with the shells 2, 3 so that the part 1 forms a monobloc assembly.

The part 1 is then advantageously produced by an additive manufacturing method, as provided for in the application WO-A1-2019/063458, which allows to produce the complex shapes shown in the example, in particular with a view to promoting the separation of the oil droplets from the mixture while minimising the pressure losses. The additive manufacturing can be carried out in a known way using a laser fusion method on metal powder beds.

In the prior technique, once the part 1 and therefore the lattice structure 17 have been manufactured, the latter is engaged onto one end of the shaft 14 and attached to it by means of a nut 20 (see FIG. 1).

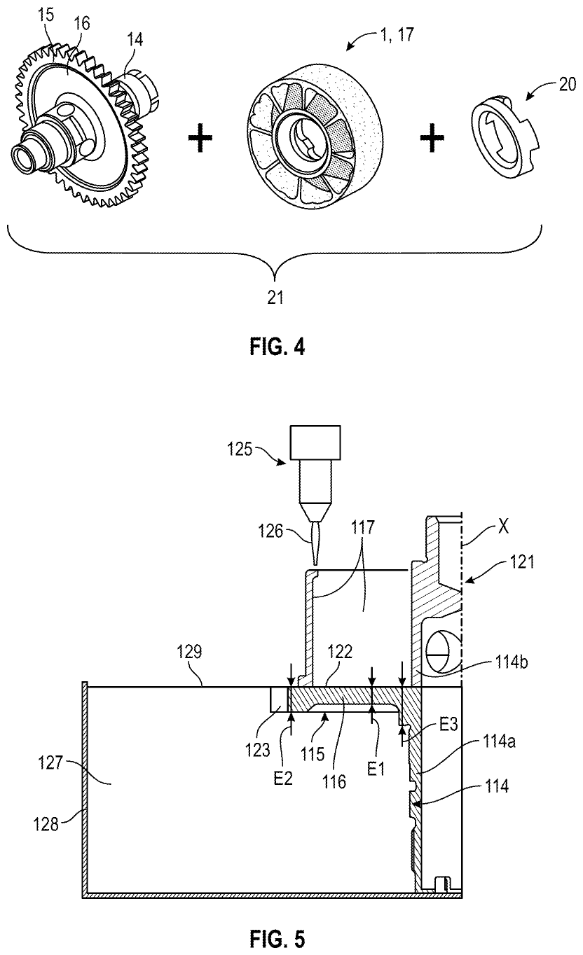

The rotor 21 of the breather is then formed by assembling the parts shown in FIG. 4, i.e. the shaft 14 secured to the pinion 15, the part 1 and its annular lattice structure 17, which can form a monobloc assembly, and the nut 20.

The invention proposes a rotor 21 that is optimised and in particular simplified in that it does not comprise any element for attaching the lattice structure 17 to the pinion or the shaft 14.

FIGS. 5 to 7 illustrate one embodiment of the invention, namely on the one hand a rotor 121 for a centrifugal breather, and on the other hand a method for manufacturing this rotor 121.

The rotor 121 essentially comprises three portions:
a hollow shaft 114 extending along an axis X and defining an internal air circulation cavity after separation of the air/oil mixture,
a pinion 115 for rotating the hollow shaft 114, this pinion 115 extending about the axis X and being formed in one piece and from a first material with at least one first portion 114a of the hollow shaft 114, and
an annular lattice structure 117 extending around the axis X and secured in rotation to the shaft 114, this structure 117 being made of a second material different from the first material and being configured to ensure the centrifugal separation of the mixture, as mentioned above.

According to the invention, the structure 117 is made secured to the shaft 114 by the additive manufacturing of this structure 117 directly on at least one annular surface 122 of the pinion 115 which forms at least one annular support surface for this additive manufacturing (see FIG. 5).

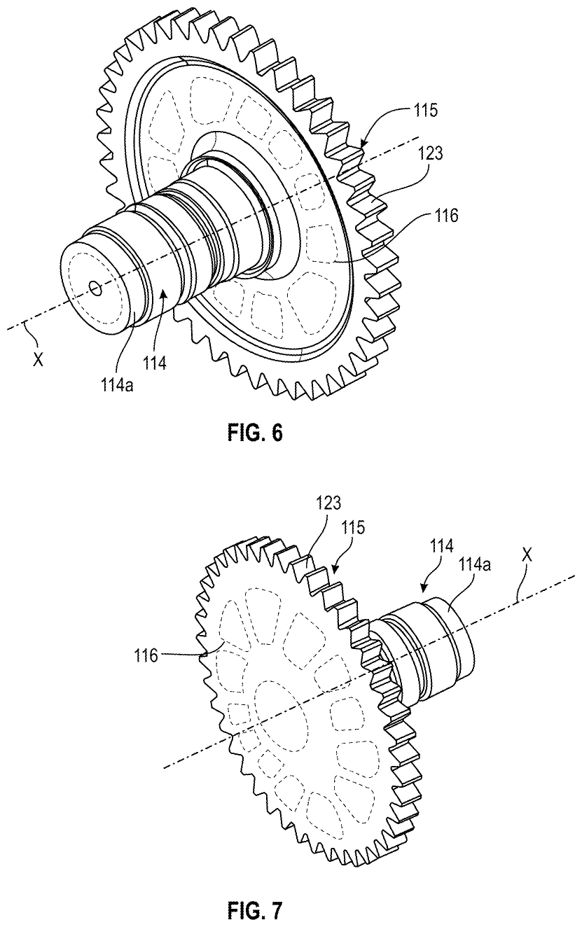

FIGS. 6 and 7 show a first step in manufacturing the rotor 121, which consists of manufacturing the pinion 115 and at least one portion 114a of the hollow shaft 114 from a single piece and in a first material.

In the example shown, the pinion 115 is located at one longitudinal end of the first portion 114a of the shaft 114. The annular surface 122 on which the lattice structure 117 is formed is located on a side of the pinion 115 opposite to this first portion 114a of the shaft 114.

The annular surface 122 is perpendicular to the axis X. This surface 122 is unique here (the pinion 115 does not comprise other surfaces intended to receive the lattice structure 117).

The pinion 115 has an external periphery comprising a toothing 123, an internal periphery connected to the shaft 114, and an intermediate annular web 116 extending between its internal and external peripheries.

The web 116 preferably has a thickness E1 measured along the axis X which is less than the thicknesses E2, E3 of the peripheries measured along the same axis X.

Unlike the prior art, in which the annular structure 117 is manufactured and then fitted and attached to the shaft 114 and the pinion 115, the structure 117 is manufactured and secured simultaneously to the pinion 115.

To achieve this, the structure 117 is made from a second material by additive manufacturing directly on the surface 122 of the pinion 115.

As shown schematically in FIG. 5, the additive manufacturing can be of the powder bed type. As is well known to a person skilled in the art, a head 125 emitting a laser beam 126 scans the surface of a bed of powder 127 contained in a tank 128. The tank 128 comprises several superimposed layers of powder and the upper layer of powder 129 is scanned by the laser beam 126 in a predetermined pattern to melt the powder and generate a bead of molten material.

The pinion 115 forms a support plate for additive manufacturing and comprises a first layer of powder evenly distributed over its surface 122. The plate 115 is movable in the tank 128 along the axis X, which is oriented vertically.

Once the first layer has melted, the pinion 115 is lowered into the tank 128 and a new layer of powder is spread over the pinion 115 and the layer that has already melted. The laser 126 is again used to melt this new layer and this process is repeated as many times as necessary until the annular structure 117 is completely formed by stacking strands of melted material on top of each other along the axis X.

FIG. 5 allows to show that an upper portion 114b of the shaft 114 is produced simultaneously with the annular structure 117 by additive manufacturing. This second portion 114b is located at the internal periphery of the structure 117 and extends towards the top of the pinion 115 from its surface 122 and in the extension with the first portion 114a of the shaft 114 located under the pinion 115 and in the tank 128.

The pinion 115 and the portion 114a of the shaft are preferably obtained by machining a metal alloy block prior to the additive manufacturing.

The material of the pinion 115 and of the portion 114a of the shaft 1114 is preferably chosen from E16NCD13 and E32CDV13. This material is preferably nitrided or case-hardened to make its external surface harder. The hardening of the external surface of the pinion 115 and in particular its toothing 123 is important to optimise its service life.

The material of the lattice structure 117 is preferably stainless steel, for example of the type 17-4 PH. Unlike aluminium, for example, a steel lends itself well to the laser fusion, and allow to produce fine structures without the risk of fusion anomalies.

To date, there is no additive manufacturing material that guarantees sufficient mechanical properties to withstand fatigue. The additive manufacturing materials cannot therefore be used to produce the pinion 115 and its toothing 123. It is therefore important that the pinion 115 can be made from a different material to that used for the additive manufacturing, and the solution was found to produce this pinion by machining a block of material, as mentioned above.

Some finishing or machining operations on the pinion 115 can be carried out after the additive manufacturing of the lattice structure 117. This is particularly the case when the pinion 115 and the shaft 114 are pierced along the axis X to produce the internal cavity of the shaft, which is shown in dotted lines in FIGS. 6 and 7. This is also the case for the openings in the web 116 of the pinion 115, which are shown as dotted lines in these figures.

The production of these piercings and openings after the additive manufacturing allows a good material continuity and makes it easier to support the layers and the powder during the additive manufacturing. It is also conceivable that the bearing seats of the guide rolling of the shaft 114 could be reworked after the additive manufacturing, and the toothing 123 of the pinion 115 rectified after this additive manufacturing, to correct any deformation and ensure a perfect coaxiality of the various portions of the rotor 121.

The invention thus allows to create a robust, non-removable connection between the lattice structure 117 and the pinion 115, and thus to maximise the volume of the cells in this structure. The additive manufacturing of the structure 117 allows, for example, to obtain cells or strands of lattice of small dimensions, for example between 0.4 mm and 0.7 mm in diameter.

1. A rotor for a centrifugal breather for a turbomachine air/oil mixture, this rotor comprising:
a hollow shaft extending along an axis and defining an internal air circulation cavity after separation of said mixture,
a pinion for rotating the hollow shaft, this pinion extending about the axis and being formed in one piece and from a first material with at least one first portion of the hollow shaft, and
an annular structure, preferably in the form of a lattice, extending around the axis and secured in rotation to the shaft, this structure being made of a second material different from the first material and being configured to ensure a centrifugal separation of said mixture,
wherein said structure is made secured to the shaft by the additive manufacture of this structure directly on at least one annular surface of the pinion which forms at least one annular support surface for this additive manufacture.

2. The rotor according to claim 1, wherein the pinion is located at a longitudinal end of said first portion of said shaft and said at least one annular surface is located on a side of the pinion opposite to this first portion.

3. The rotor according to claim 1, wherein said at least one annular surface is perpendicular to said axis.

4. The rotor according to claim 1, wherein said structure is produced by additive manufacturing on a single annular surface of the pinion, this surface being flat and extending from the internal periphery of the pinion to the external periphery of the pinion.

5. The rotor according to claim 1, wherein the pinion has an external periphery comprising a toothing, an internal periphery connected to the shaft, and an intermediate annular web extending between its internal and external peripheries and having a thickness measured along said axis which is less than the thicknesses of said peripheries measured along the same axis.

6. The rotor according to claim 1, wherein the annular structure is made in one piece and from said second material with at least one second portion of said shaft.

7. The rotor according to claim 1, wherein the first material is chosen from a steel that is hardenable by thermal treatment of case-hardening or nitriding, for example of the E16NCD13 and E32CDV13 type.

8. The rotor according to claim 1, wherein the second material is a stainless steel, for example of the 17-4 PH type.

9. A centrifugal breather for a turbomachine air/oil mixture, comprising a rotor according to claim 1.

10. A method for manufacturing a rotor according to claim 1, characterised in that it comprises the steps of:
a) manufacturing the pinion and at least one portion of the hollow shaft in a single piece and from a first material,
b) additive manufacturing, for example on powder beds, of the annular structure in a second material directly on at least one annular surface of the pinion.

11. The method according to claim 10, wherein the pinion is located at a longitudinal end of said first portion of said shaft and said at least one annular surface is located on a side of the pinion opposite to this first portion.

12. The method according to claim 10, wherein the pinion has an external periphery comprising a toothing, an internal periphery connected to the shaft, and an intermediate annular web extending between its internal and external peripheries and having a thickness measured along said axis which is less than the thicknesses of said peripheries measured along the same axis.

13. The method according to claim 10, wherein step a) comprises machining a metal alloy block, and also preferably treating this block after machining by case-hardening or nitriding.

14. The method according to claim 10, wherein step b) comprises simultaneously manufacturing the annular structure and a second portion of said shaft.

15. The method according to claim 14, wherein the second portion is located at the internal periphery of the structure and extends towards the top of the pinion from its surface and in the extension of the first portion of the shaft.
